(19) United States
(12) Patent Application Publication
(10) Pub. No.: US 2005/0233630 A1
(43) Pub. Date: Oct. 20, 2005

(54) Socket connector having improved structural intensity

(75) Inventors: Yao-Chi Huang, Tu-chen (TW); Ming-Yu Chen, Tu-chen (TW)

Correspondence Address: WEI TE CHUNG;FOXCONN INTERNATIONAL, INC., 1650 MEMOREX DRIVE, SANTA CLARA, CA, 95050, US

(73) Assignee: HON HAI PRECISION IND. CO., LTD.

(21) Appl. No.: 11/026,595

(22) Filed: Dec. 30, 2004

(30) Foreign Application Priority Data
Apr. 16, 2004 (TW) 93110621

(51) Int. Cl. H01R 4/50

(52) U.S. Cl. 439/342

(57) ABSTRACT

A socket connector electrically connecting an IC package to a printed circuited board includes a base (3) defining a number of side walls and a receiving region (38), a cover (5) slidably mounted on the receiving region, a lever (6) defining a cam shaft (61) received in the base and an operation handle (62) vertically extending from the cam shaft and a plurality of terminals received in the base. The cover is mounted over the receiving region and enwrapped by the side walls.

### BACKGROUND OF THE INVENTION

1. Field of the Invention

The present invention relates to a socket connector, and particularly to a socket connector for electrically connecting an IC package to a printed circuit board (PCB).

2. Description of Related Arts

With the development of technology, socket connectors, which have pins or solder balls, are found widespread applications in computers and other electrical devices for transmitting signals and conducting current between a printed circuit board (PCB) and an IC package. A typical socket connector comprises a plate-like base having a plurality of passageways vertically extending therethrough, a cover movably mounted on the base, a plurality of terminals received in the passageways of the base and a lever sandwiched between the base and the cover. The cover can slide on the base by actuating the lever, which makes pins of the IC package move simultaneously for establishing/disestablishing an electrical connection between the pins of the IC package and mating portions of the terminals. It is noted the steady electrical connection between the IC package and the PCB is deeply affected by the planeness between the cover and the base.

Referring to FIGS. 1-2, a conventional socket connector 1 comprises a base 2, a cover 4 slidably mounted on the base 2 and a lever 12 sandwiched between the base 2 and the cover 4. The lever 12 includes a cam shaft 122 received in the base 2 and an operating handle 121 vertically extending from the cam shaft 122. The cover 4 includes a mating surface 11 for mating with an IC package (not shown), a pair of side walls 15 downwardly extending from opposite ends of the mating surface 11. The cover 4 also comprises a pair of supporting portions 14 outwardly and horizontally extending from one side wall 15 and a protrusion 13 vertically disposed in alignment with one supporting portion 14. The base 2 defines a bar 17 vertically extending from a side thereof and a block 18 vertically extending from the bar 17. In assembly, fastening the cover 4 with the base 2, then fixing the IC package on the cover 4, then actuating the lever 12 from a horizontal position to a vertical position to locate the operating handle 121 between the supporting portions 14 and the protrusion 13. The supporting portions 14 collaborate with the protrusion 13 to fasten the operating handle 121 of the lever 12, and the bar 17 collaborates with the block 18 to fasten the cam shaft 122 of the lever 12. Therefore, an electrical connection between the pins of the IC package and the terminals of the socket connector is established. Since the fixations of the operating handle 121 and the cam shaft 122 are respectively completed by the cover 4 and the base 2, the cover 4 and the base 2 need high anti-distortion intensity. On the other hand, the miniature trendy of electrical connectors and the increasing pin counts of the IC package all increase the distortion demand of the plastic cover and the base. This problem needs to be solved.

Hence, a socket connector having improved structural intensity is desired.

### SUMMARY OF THE INVENTION

Accordingly, an object of the present invention is to provide a socket connector having improved structural intensity, thereby improving the planeness of the socket connector.
another object of the present invention is to provide a socket connector having an improved fastening member which can ensure a reliable connection between the base and the cover.

To achieve the above objects, a socket connector in according with the present invention comprises a base defining a pair of opposite first side walls and a pair of opposite second side walls connecting with opposite first side walls, which together define an elongated receiving region, a cover slidably mounted on the receiving region, a lever sandwiched between the base and the cover, and defining a cam shaft received and an operation handle vertically extending from the cam shaft and a plurality of terminals received in the base. The cover is mounted on the receiving region and enwrapped by the first and second side walls for improving intensity of the socket connector.

Other objects, advantages and novel features of the invention will become more apparent from the following detailed description of the present embodiment when taken in conjunction with the accompanying drawings.

### BRIEF DESCRIPTION OF THE DRAWING

FIG. 1 is a perspective, exploded view of a conventional socket connector;

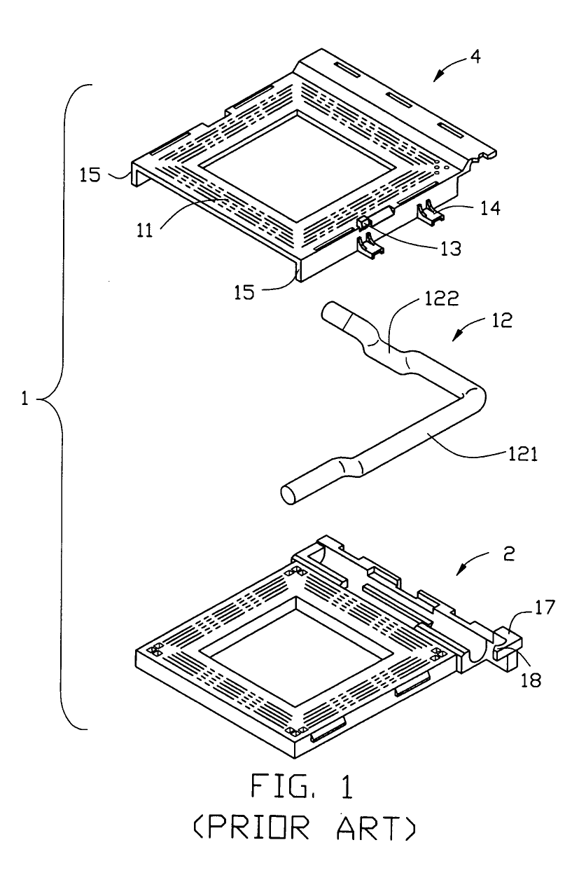

FIG. 2 is a perspective, assembled view of the conventional socket connector of FIG. 1;

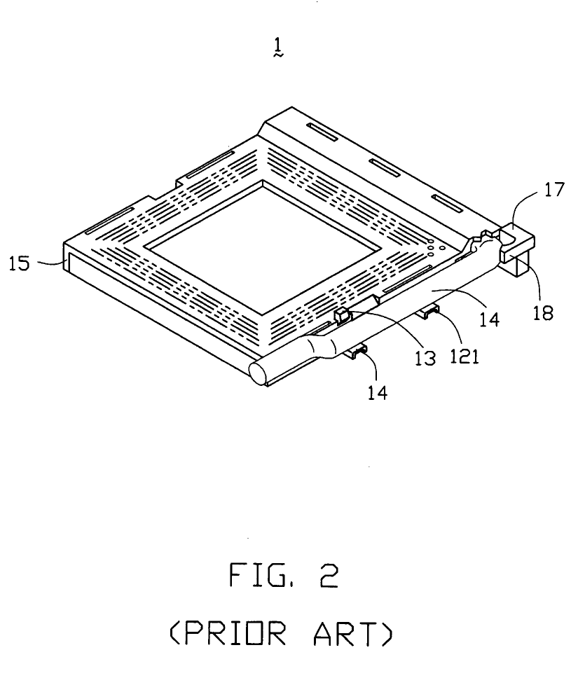

FIG. 3 is a perspective, exploded view of a socket connector in accordance with the present invention;

FIG. 4 is a view similar to FIG. 3, but taken from a different aspect;

FIG. 5 is a partially perspective, assembled view of FIG. 3.

### DETAILED DESCRIPTION OF THE PREFERRED EMBODIMENT

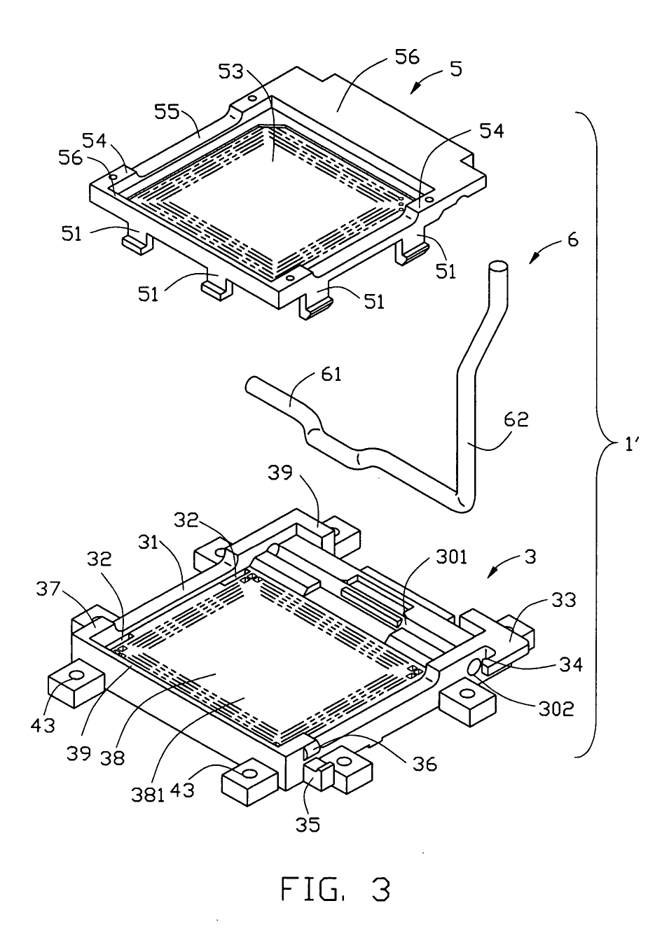

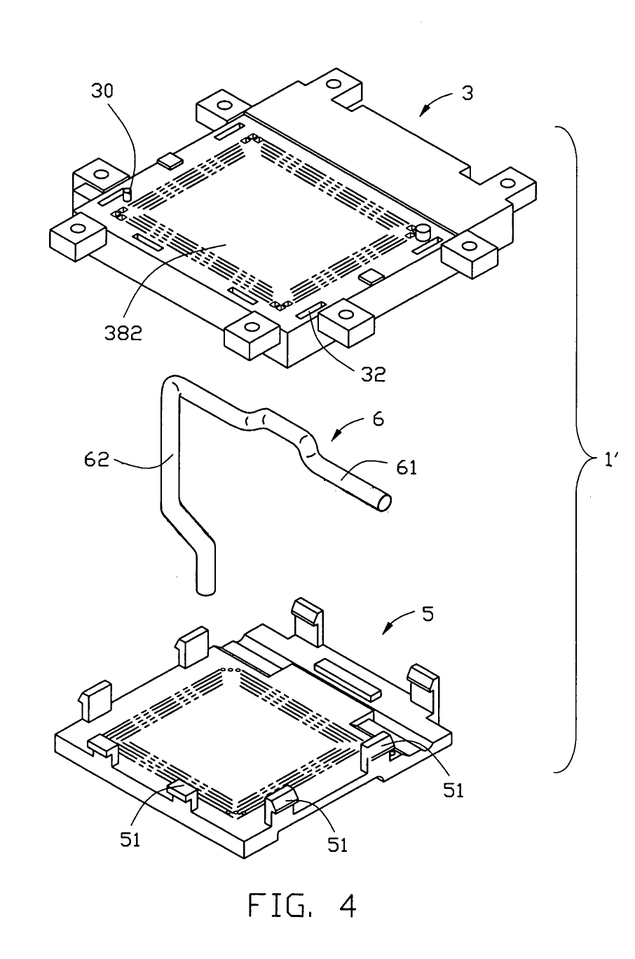

Referring to FIGS. 3-4, a socket connector 1′ in accordance with the present invention comprises a base 3, a lever 6, a cover 5 slidably mounted on the base 3 and a plurality of terminals (not shown) received in the base 3.

The lever 6 sandwiched between the base 3 and the cover 5 includes a cam shaft 61 received in the base 3 and an operation handle 62 exposed to and accessible from outside. The operation handle 62 vertically extending from an end of the cam shaft 61 is generally of L-shaped configuration.

The base 3 comprises a pair of opposite first side walls 37 and a pair of opposite second side walls 39 connecting with the first side walls 37, which together define an elongated receiving region 38. The receiving region 38 defines a cambered slot 301. A pair of apertures 302 are respectively formed in opposite first side walls 37 to communicate with the slot 301. A plurality of inserting slots 32 are disposed within the receiving region 38 and adjacent to opposite first side walls 37 and second side walls 39. These inserting slots 32 all penetrate from a top surface 381 of the receiving region 38 to a bottom surface 382 of the receiving region 38 respectively. In addition, according to determinate types of socket connectors, the bottom surface 382 of the receiving region 38 may form a plurality of posts 30 for engaging with corresponding holes (not shown) disposed in a printed circuit board (PCB, not shown). The first side walls 37 and the second side walls 39 are higher than the top surface 381 of the receiving region 38. Each first side wall 37 is partially cutoff to define an opening 31 to provide an operation area for user's fingers operating an IC package conveniently. A fixing portion 33 vertically extending from one first side wall 37 is disposed adjacent to the aperture 302, a block 34 is formed on the fixing portion 33. The first side wall 37, on which the fixing portion 33 and the block 34 are disposed, also comprises a protrusion 35 outwardly extending from a lower end thereof and a flange 36 outwardly extending from a top end thereof. The first side walls 37 and the second side walls 39 form a plurality of securing portions (not labeled) outwardly extending therefrom. Each securing portion defines a hollow 43 for assembling the socket connector 1′ with the printed circuit board by twisting screws (not shown) into the hollows 43 and the holes (not shown) of the printed circuit board.

The cover 5 is generally of a rectangular configuration and comprises a pair of first lateral walls 54, a pair of second lateral walls 56, which together define a rectangular receiving cavity 53 similar to the receiving region 38 of the base 3 for receiving the IC package. Each first lateral wall 54 is partially cutoff to define a hatch 55 corresponding to the opening 31 for operating conveniently. A plurality of locking barbs 51 are respectively disposed on the first and second lateral walls 54 in alignment with the corresponding inserting slots 32. The locking barbs 51 and the inserting slots 32, which function as a fastening member, hook with each other for fixing the cover 5 on the base 3.

In assembly, The cam shaft 61 of the lever 6 is received in the cambered slot 301 with opposite ends rotatably received in the apertures 302. By driving the operation handle 62, the cam shaft 61 of the lever 6 may rotate to a determined position. The fixing portion 33 and the block 34 abut against the operation handle 62 for prohibiting the cam shaft 61 disengaging from the base 3 or the operation handle 62 being deflected excessively. When the operation handle 62 is actuated to a horizontal position, the protrusion 35 and the flange 36 abut against and fasten the operation handle 62 to the first side wall 37.

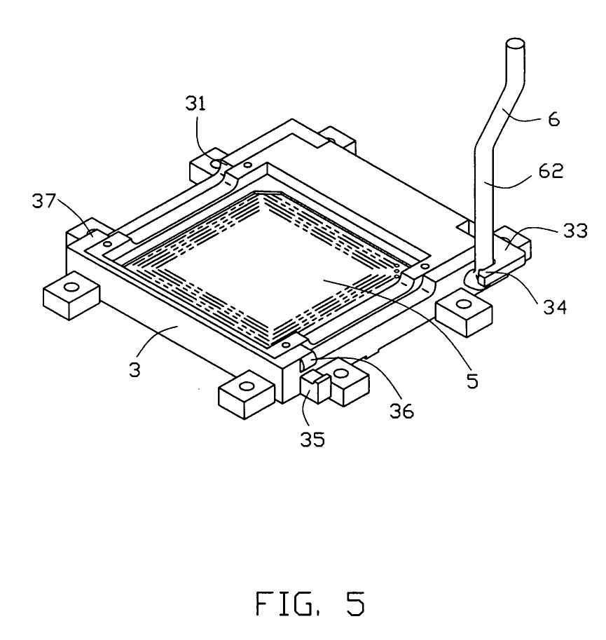

In conjunction with FIG. 5, the cover 5 laid on the base 3 and received in the receiving region 38 is enwrapped by the first side walls 37 and the second side walls 39 with a top surface thereof is coplanar with those of the first and second side walls 37, 39. The locking barbs 51 penetrate through the inserting slots 32 and clasp the bottom surface 382 of the receiving region 38. In an alternate embodiment, the locking barbs also can be disposed on the base 3. On the contrary, the cover 5 defines inserting slots corresponding to the locking barbs.

The IC package is received in the receiving cavity 53, wherein the pins of the IC package are in an disengagement position with the terminals of the socket connector 1′. The operation handle 62 being actuated by a user drives the cam shaft 61 to rotate, thereby inducing the cover 5 to slide over the receiving region 38 and ensuring an electrical connection between the pins of the IC package and the terminals of the socket connector 1′.

It is noted that the socket connector 1′ of the present invention defines a pair of opposite first side walls 37, a pair of opposite second side walls 39 for enwrapping the cover 5 completely, which effectively improves structural intensity of the socket connector 1′, and avoids distortion that may occur while the engagement between the cover 5 and the base 3. Consequently, A high planeness of the socket connector 1′ is established. In addition, different from conventional socket connector, in which the locking barbs hook with the base from the outside of side walls, the locking barbs 51 of the cover 5 according to the present invention lock with the base 3 within the receiving region 38. Thereby, the base 3 may engage with the cover 5 more reliably and space spared.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

1. A socket connector, comprising:
a base comprising a plurality of side walls and a receiving region circumscribed by said side walls;
a plurality of terminals received in the base;
a cover enwrapped by the side walls and slidably mounted on the receiving region;
a lever sandwiched between the base and the cover and comprising a cam shaft and an operation handle extending from said cam shaft.

2. The socket connector as described in claim 1, wherein the side walls comprise a pair of first side walls and a pair of second side walls respectively connecting with the first side walls.

3. The socket connector as described in claim 2, wherein the base further comprises a fixing portion disposed on one first side wall and a block formed on the fixing portion for prohibiting the cam shaft disengaging from the base and the operation handle being deflected excessively.

4. The socket connector as described in claim 2, wherein the base further comprises a protrusion outwardly extending from one first side wall and a flange opposite to the protrusion.

5. The socket connector as described in claim 2, wherein said opposite first side walls comprises a pair of openings for a user operating conveniently.

6. The socket connector as described in claim 5, wherein the top surface of the side walls are higher than the top surface of the receiving region.

7. The socket connector as described in claim 1, wherein the socket connector further comprises a fastening member formed in the base and the cover for locking the base and cover reliably.

8. The socket connector as described in claim 7, wherein the fastening member comprises a plurality of inserting slots disposed in the cover, and a plurality of locking barbs disposed in the base in alignment with the corresponding inserting slots.

9. The socket connector as described in claim 7, wherein the fastening member comprises a plurality of inserting slots disposed in the base, and a plurality of locking barbs disposed in the cover in alignment with the corresponding inserting slots.

10. The socket connector as described in claim 9, wherein the inserting slots are disposed within the receiving region and adjacent to opposite first and second side walls.

11. The socket connector as described in claim 10, wherein the inserting slots penetrate through the base for allowing the locking barbs extending through therethrough.

12. The socket connector as described in claim 1, wherein the base comprises a plurality of securing portions disposed on the said side walls, each securing portion defines a hollow thereof.

13. The socket connector as described in claim 1, wherein the base comprises a plurality of posts downwardly extending from the receiving region for engaging with corresponding holes of a printed circuit board.

14. A socket connector, comprising:
a base comprising a receiving region and a plurality of the inserting slots disposed within the receiving region;
a plurality of terminals received in the base;
a cover slidably mounted on the receiving region and comprising a plurality of locking barbs in alignment with corresponding inserting slots for hooking with the base;
a lever sandwiched between the base and the cover and comprising a cam shaft and an operation handle extending from the cam shaft.

15. The socket connector as described in claim 14, wherein the base comprise a pair of opposite first side walls and a pair of opposite second side walls vertically connecting with the first side walls.

16. The socket connector as described in claim 15, wherein the cover comprise a pair of first lateral walls corresponding to the first side walls and a pair of second lateral walls corresponding to the second side walls.

17. The socket connector as described in claim 16, wherein the top surfaces of the first and the second side walls are coplanar with those of the first and the second lateral walls.

18. A socket connector, comprising:
a base defining two opposite side exterior surfaces;
a plurality of passageways extending through the base in a vertical direction;
a plurality of contacts received in the corresponding passageways, respectively;
a cover defining two opposite side exterior faces and mounted on the base and movable relative to the base along a front-to-back direction perpendicular to said vertical direction; and
a lever sandwiched between the base and the cover and comprising a cam shaft extending along a lateral direction perpendicular to both said vertical and front-to-back directions, and an operation handle extending from said cam shaft and moveable along a plane defined by said vertical direction and said front-to-back direction; wherein
a distance between the two opposite exterior surfaces of the base is larger than a distance between the two opposite exterior faces of the cover.

19. The socket connector as claimed in claim 18, wherein a stopper is formed on the exterior surface of the base to hold the operation handle in a horizontal position and prevents said operation handle from inadvertently upwardly moving.
